(19) United States
(12) Patent Application Publication
(10) Pub. No.: US 2017/0298249 A1
(43) Pub. Date: Oct. 19, 2017

(54) MULTILAYERED POLYIMIDE FILM CONTAINING SILOXANE, AND ITS FABRICATION AND APPLICATION

(71) Applicant: TAIMIDE TECHNOLOGY INCORPORATION, Xinpu Township (TW)

(72) Inventors: Chih-Wei Lin, Hsinchu Hsien (TW); Chun-Ting Lai, Hsinchu Hsien (TW); Yen-Po Huang, Hsinchu Hsien (TW)

(21) Appl. No.: 15/131,990

(22) Filed: Apr. 18, 2016

(51) Int. Cl. C09D 179/08

(52) U.S. Cl. CPC C09D 179/08

(57) ABSTRACT

The present disclosure relates, according to some embodiments, to a multilayered polyimide film comprising a peelable base layer, and a polyimide layer adhered in contact with the peelable base layer. A peelable base layer may be derived from a reaction comprising a diamine compound and a dianhydride compound, wherein the peelable base comprises a polyimide and a structure according to formula (I):

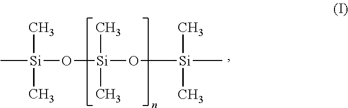

wherein n is a number of repeating units. According to some embodiments, a quantity of silicon atoms present in a peelable base layer comprises about 1% to about 12% of a total weight of the peelable base layer.

### FIELD OF THE DISCLOSURE

The present application relates, in some embodiments, to a multilayered polyimide film and its fabrication and application.

### BACKGROUND OF THE DISCLOSURE

A polyimide coverlay is conventionally used to cover and protect metal circuits formed on a printed circuit board (PCB). As technology advances, the printed circuit board becomes increasingly thinner, lighter and multi-functional. A thin printed circuit board may require the use of an ultra-thin polyimide coverlay.

Ultra-thin polyimide films are difficult to fabricate with current processing methods. Some polyimide films currently available on the market may have a thickness of less than 10 However, polyimide films with a thickness of less than 5 μm are usually not subjected to biaxial orientation, because the stretching process may break the polyimide film. Moreover, the fabrication of the current ultra-thin polyimide films generally may not consider difficulties that may arise during the assembly of the polyimide film on a substrate of a printed circuit board, such as coating of an adhesive agent on the polyimide film.

Accordingly, there is a need for ultra-thin polyimide films that are convenient to process, and address at least the foregoing issues.

### SUMMARY

The present disclosure relates, according to some embodiments, to a multilayered polyimide film comprising siloxane. In some embodiments, the present disclosure relates to a fabrication, an application, or a combination thereof of a multilayered polyimide film comprising siloxane. In some embodiments, a multilayered polyimide film comprises a peelable base layer and a polyimide layer adhered in contact with a surface of a peelable base layer. A peelable base layer may be derived from a reaction comprising a diamine compound and a dianhydride compound, wherein the peelable base layer may comprise a polyimide and a structure according to formula (I):

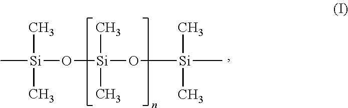

wherein n is a number of repeating units. According to some embodiments, a quantity of silicon atoms present in the peelable base layer comprises about 1% to about 12% of a total weight of a peelable base layer.

According to some embodiments, a multilayered polyimide film comprises a peelable base layer, and a polyimide layer adhered in contact with a surface of a peelable base layer. In some embodiments, a peelable base layer may be derived from a reaction comprising a diamine compound and a dianhydride compound, wherein the peelable base layer may comprise a polyimide and a structure according to formula (II):

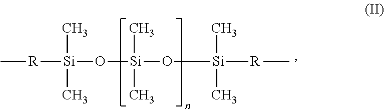

wherein n is a number of repeating units, and R represents C1-C10 aliphatic group.

### BRIEF DESCRIPTION OF THE DRAWINGS

FIG. 1 illustrates a multilayered polyimide film containing siloxane according to a specific example embodiment of the disclosure;

FIG. 2 illustrates a multilayered polyimide film of FIG. 1 provided with an adhesive layer disposed on a surface of a polyimide layer in a multilayered polyimide film according to a specific example embodiment of the disclosure; and

FIGS. 3-5 illustrate applications of the multilayered polyimide film according to a specific example embodiment of the disclosure.

### DETAILED DESCRIPTION OF THE EMBODIMENTS

The present application relates, in some embodiments, to a multilayered polyimide film comprising siloxane. A multilayered polyimide film may comprise a peelable base layer derived from a reaction comprising a diamine compound and a dianhydride compound, wherein the peelable base layer comprises a polyimide and a structure according to formula (I):

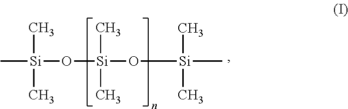

wherein n is a number of repeating units. According to some embodiments, for forming a multilayered polyimide film, a precursor polyamic acid solution may be derived from a reaction comprising a diamine compound and a dianhydride compound, wherein a portion of the diamine or the dianhydride compound comprises siloxane. In some embodiments, a diamine or a dianhydride compound comprising siloxane may comprise a structure according to formula (I-A):

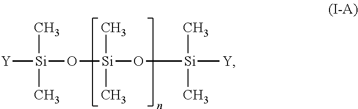

wherein n is a number of repeating units, and Y is either a diamine monomer a dianhydride monomer, or a combination thereof.

In some embodiments, a multilayered polyimide film comprises a peelable base layer derived from a reaction of a diamine compound with a dianhydride compound, wherein the peelable base layer comprises a polyimide and a structure according to formula (II):

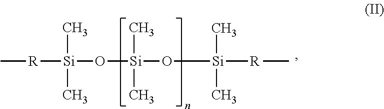

wherein n is a number of repeating units, and R is a C1-C10 aliphatic group. According to some embodiments, a multilayered polyimide film maybe formed in a similar way as above mentioned, except that the diamine or dianhydride compound containing siloxane may have a structure according to formula (II-A):

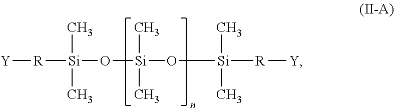

wherein n is a number of repeating units, Y is either a diamine monomer, a dianhydride monomer, or a combination thereof; and R represents C1-C10 aliphatic group (such as methylene, ethylene or propylene), or aromatic group.

According to some embodiments, Y in formula (I-A) or (II-A) is a diamine monomer, which may be selected from a group consisting of 4,4′-oxydianiline (4,4′-ODA), phenylenediamine (p-PDA), and 2,2′-Bis(trifluoromethyl)benzidine (TFMB). According to some embodiments, Y in formula (I-A) or (II-A) is a dianhydride monomer, which may be selected from a group consisting of pyromellitic dianhydride (PMDA), 3,3′,4,4′-biphenyltetracarboxylic dianhydride (BPDA), and 2,2-bis [4-(3,4dicarboxyphenoxy) phenyl] propane dianhydride (BPADA).

### Specific Example Embodiments

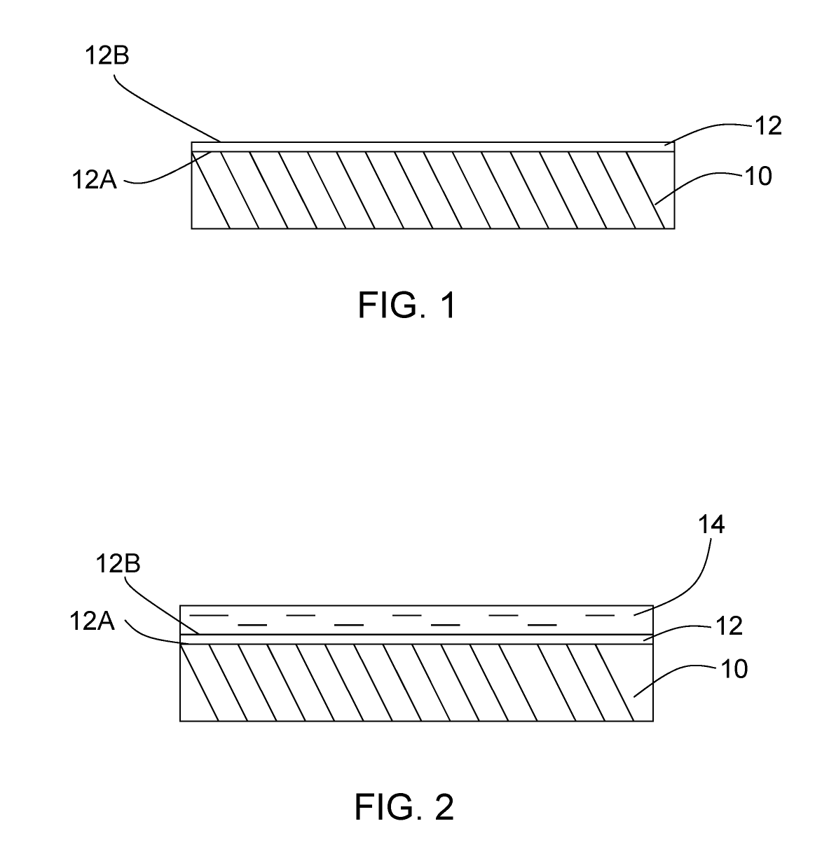

Specific example embodiments of a multilayered polyimide film containing siloxane are illustrated in FIG. 1. According to some embodiments, a multilayered polyimide film comprises a peelable base layer 10 and a polyimide layer 12 stacked on each other. A peelable base layer 10 may comprise a polyimide and a structure according to formula (I). In some embodiments, a peelable base layer 10 may comprise a polyimide and a structure according to formula (II). According to some embodiments, a peelable layer 10 may comprise a polyimide, wherein the polyimide may be derived from a polyamic acid to solution. According to some embodiments, a polyamic acid solution may be derived from a reaction comprising a diamine compound with and a dianhydride compound, wherein a portion of the diamine or the dianhydride compound comprises a structure according to formula (I-A) or (II-A). According to some embodiments, a quantity of silicon atoms present in a base layer 10 may comprise from about 1% to about 12% of a total weight of the base layer 10.

In some embodiments, a peelable base layer 10 may comprise a thickness, wherein the thickness may provide support for a polyimide layer 12. In some embodiments, a base layer 10 may comprise a thickness of about 5 μm to about 10 In other embodiments, a peelable base layer may comprise a thickness of 10 μm or greater.

According to some embodiments, a polyimide layer 12 comprises two opposite surfaces 12A and 12B. In some embodiments a surface 12A may be attached with a peelable base layer 10. A polyimide layer 12 may be derived from a reaction comprising a diamine compound and a dianhydride compound, wherein the diamine compound has no siloxane, the dianhydride compound has no siloxane, or a combination thereof. In some embodiments, the diamine compound may comprise 4,4′-oxydianiline (4,4′-ODA), phenylenediamine (p-PDA), 2,2′-Bis(trifluoromethyl)benzidine (TFMB), and combinations thereof, wherein the diamine compound may be used for forming a polyimide layer 12. According to some embodiments, the dianhydride compound may comprise pyromellitic dianhydride (PMDA), 3,3′,4,4′-biphenyl-tetracarboxylic dianhydride (BPDA), 2,2-bis [4-(3,4dicarboxyphenoxy) phenyl] propane dianhydride (BPADA), and combinations thereof, wherein the dianhydride compound may be used for forming a polyimide layer 12. In some embodiments, a polyimide layer 12 may comprise at least one pigment, wherein the at least one pigment comprises carbon black, titanium dioxide, and combinations thereof.

In some embodiments, a polyimide layer 2 may be an ultra-thin layer. An ultra-thin layer may comprise a thickness of about 0.1 μm to about 6 μm. In some embodiments, an ultra-thin layer may comprise a thickness, the thickness comprising about 0.1 μm, about 1 μm, about 2 μm, about 2.5 μm, about 3 μm, about 4 μm, about 4.5 μm. In some embodiments, a polyimide layer 2 may comprise a thickness of about 0.1 μm to about 6 μm. In some embodiments, a polyimide layer 2 may comprise a thickness, the thickness comprising about 0.1 μm, about 1 μm, about 2 μm, about 2.5 μm, about 3 μm, about 4 μm, about 4.5 μm.

According to some embodiments, a multilayered polyimide film comprises a peelable base layer 10 and a polyimide layer 12. A peelable base layer 10 may be prepared from a first polyamic acid solution. A first polyamic acid solution may be derived from a reaction of a diamine compound with a dianhydride compound, wherein a portion of the diamine compound or dianhydride compound may contain siloxane. A diamine compound or dianhydride compound containing siloxane may comprise a structure according to formula (I-A) or (II-A). According to some embodiments, a first polyamic acid solution may comprise about 1% to about 12% silicon atoms with respect to a total weight of the first polyamic acid solution.

As described previously, a diamine compound containing siloxane (e.g. formula (I-A) or (II-A)) may have a diamine monomer (i.e., Y in formula (I-A) or (II-A)) selected from the group consisting of 4,4′-oxydianiline (4,4′-ODA), phenylenediamine (p-PDA), and 2,2′-Bis(trifluoromethyl)benzidine (TFMB). A dianhydride compound (e.g., formula (I-A) or (II-A)) comprising siloxane may have a dianhydride monomer (i.e., Y in formula (I-A) or (II-A)) selected from the group consisting of pyromellitic dianhydride (PMDA), 3,3′,4,4′-biphenyl-tetracarboxylic dianhydride (BPDA), and 2,2-bis [4-(3,4dicarboxyphenoxy) phenyl] propane dianhydride (BPADA).

Aside the portion of the diamine or dianhydride compound containing siloxane, the remaining portions of the diamine and dianhydride compounds used for forming the peelable base layer 10 have no siloxane. The diamine or dianhydride compound having no siloxane can be respectively similar or different from the diamine or dianhydride monomer in the diamine or dianhydride compound containing siloxane. In some embodiments, the diamine compound having no siloxane may comprise 4,4′-oxydianiline (4,4′-ODA), phenylenediamine (p-PDA), 2,2′-Bis(trifluoromethyl)benzidine (TFMB), 1,3-bis(4-aminophenoxy) benzene (TPER), 1,4-bis(4-aminophenoxy) benzene (TPEQ), 2,2′-dimethyl[1,1′-biphenyl]-4,4′-diamine (m-TB-HG), 1,3′-Bis(3-aminophenoxy) benzene (APBN), 3,5-Diaminobenzotrifluoride (DABTF), 2,2′-bis[4-(4-aminophenoxy) phenyl]propane (BAPP), 6-amino-2-(4-aminophenyl) benzoxazole (6PBOA), 5-amino-2-(4-aminophenyl)benzoxazole (5PBOA), and any combinations thereof. In some embodiments, the dianhydride compound having no siloxane may comprise 3,3′,4,4′-biphenyltetracarboxylic dianhydride (BPDA), 2,2-bis [4-(3,4dicarboxyphenoxy) phenyl] propane dianhydride (BPADA), pyromellitic dianhydride (PMDA), 2,2′-Bis-(3,4-Dicarboxyphenyl) hexafluoropropane dianhydride (6FDA), 4,4-Oxydiphthalic anhydride (ODPA), Benzophenone tetracarboxylic dianhydride (BTDA), 3,3′,4,4′-dicyclohexyltetracarboxylic acid dianhydride (HBPDA), and any combinations thereof.

A layer of a first polyamic acid solution may be coated on a support plate. A layer of a second polyamic acid solution used for forming a polyimide layer 12, which may then be coated on a layer of a first polyamic acid solution, wherein both layers may be heated to form a multilayered polyimide film comprising a polyimide layer 12 and a peelable base layer 10, that may be stacked on each other. In some embodiments, both layers may be heated at a temperature comprising about 90° C. to about 350° C., wherein a multi-layered film may be formed. In some embodiments, a polyimide layer 12 of a multilayered film may be substantially thin. In some embodiments, a polyimide layer 12 may comprise a thickness, wherein the thickness comprises about 0.1 μm to about 5 μm.

In certain embodiments, a multilayered film comprises a peelable base layer 10 and a polyimide layer 12. In some embodiments, a multilayered film may undergo a biaxial stretching process, wherein both a peelable base layer 10 and a polyimide layer 12 are biaxially oriented. In some embodiments, biaxially oriented comprises along a lengthwise and transversal directions of a multilayered film. In some embodiments, biaxial orientation may enhance a strength of a multilayered film. Most currently available ultra-thin polyimide films are not subjected to a biaxial stretching process, wherein the biaxial stretching process may cause break the ultra-thin polyimide films. A multilayered film may comprise an ultra-thin polyimide layer 12, wherein the multi-layered film may allow biaxial stretching without incurring damages to the ultra-thin polyimide layer 12 of the multilayered polyimide film.

A polyimide layer 12 may be formed by thermal conversion or chemical conversion. In some embodiments, when a chemical conversion is used, a dehydrant or a catalyst may be added into a first polyamic acid solution before it is coated on a layer of a first polyamic acid solution. Any suitable solvent, dehydrating agent and catalyst may be used. Solvents may comprise dimethylacetamide (DMAC), N,N′-dimethylformamide (DMF), N-methyl-2-pyrrolidone (NMP), dimethyl sulfoxide (DMSO), tetramethylene sulfone, N,N′-dimethyl-N,N′-propylene urea (DMPU), and any combinations thereof. Dehydrating agents may comprise aliphatic anhydrides (e.g., acetic anhydride and propionic anhydride), aromatic anhydrides (e.g., benzoic acid anhydride and phthalic anhydride), and any combinations thereof. In some embodiments, catalysts comprise heterocyclic tertiary amines (e.g., picoline, and pyridine), aliphatic tertiary amines (e.g., trimethylamine (TEA)), aromatic tertiary amines, and combinations thereof. A molar ratio of polyamic acid:dehydrating agent:catalyst comprises about 1:2:1. In some embodiments, for each mole of polyamic acid solution, about 2 moles of dehydrating agent and about 1 mole of catalyst are used.

A polyimide of a peelable base layer 10 and that of a polyimide layer 12 may be derived from diamine and dianhydride compounds at a substantially equal molar ratio, e.g., a diamine-to-dianhydride molar ratio may be 0.9:1.1 or 0.98:1.02.

In some embodiments, suitable diamine compounds that may be used for forming a polyimide layer 12 comprise 4,4′-oxydianiline (4,4′-ODA), phenylenediamine (p-PDA), 2,2′-Bis(trifluoromethyl)benzidine (TFMB), 1,3-bis(4-aminophenoxy)benzene (TPER), 1,4-bis(4-aminophenoxy)benzene (TPEQ), 2,2′-dimethyl[1,1′-biphenyl]-4,4′-diamine (m-TB-HG), 1,3′-Bis(3-aminophenoxy) benzene (APBN), 3,5-Diamino benzotrifluoride (DABTF), 2,2′-bis[4-(4-aminophenoxy) phenyl]propane (BAPP), 6-amino-2-(4-aminophenyl) benzoxazole (6PBOA), 5-amino-2-(4-aminophenyl) benzoxazole (5PBOA), and combinations thereof

According to some embodiments, dianhydride compounds that may be used for forming a polyimide layer 12 may comprise 3,3′,4,4′-biphenyltetracarboxylic dianhydride (BPDA), 2,2-bis [4-(3,4dicarboxyphenoxy) phenyl] propane dianhydride (BPADA), pyromellitic dianhydride (PMDA), 2,2′-Bis-(3,4-Dicarboxyphenyl) hexafluoropropane dianhydride (6FDA), 4,4-Oxydiphthalic anhydride (ODPA), Benzophenonetetracarboxylic dianhydride (BTDA), 3,3′,4,4′-dicyclohexyltetracarboxylic acid dianhydride (HBPDA), and combinations thereof.

In some embodiments, in addition to Formula (I-A) or (II-A), a diamine compound that may be used for forming a polyimide of a peelable base layer 10 may comprise 4,4′-ODA, p-PDA, TFMB, and combinations thereof. In some embodiments, in addition to Formula (I-A) or (II-A), a dianhydride compound that may be used for forming a polyimide of a peelable base layer 10 may comprise PMDA, BPDA, BPADA, and combinations thereof.

According to some embodiments, diamine compounds and dianhydride compounds that may be used for forming a polyimide layer 12 may be similar, partly similar, or different from those that may be used for forming a peelable base layer 10. In some embodiments, a diamine compound that may be used for forming a polyimide layer 12 may comprise 4,4′-ODA, p-PDA, TFMB, and combinations thereof. In some embodiments, a dianhydride compound that may used for forming a polyimide layer 12 may comprise PMDA, BPDA, BPADA, and combinations thereof.

The present application also relates, according to some embodiments, to a method of assembling a polyimide film 12 on a substrate. According to some embodiments, a multilayered polyimide film comprising a base layer 10 and a polyimide layer 12 may be positioned on a substrate, wherein the polyimide film 12 may be adhered to the substrate. In some embodiments, the substrate may comprise a printed circuit board and a base substrate.

According to some embodiments, the base layer 10 then may be peeled off from a polyimide layer 12, wherein the polyimide layer 12 may remain adhered to the substrate.

According to some embodiments, the present disclosure relates to a multilayered polyimide film comprising copolymers, wherein such copolymers may comprise, for example, polysiloxanes, polyimides, polyamic acids, and/or combinations thereof.

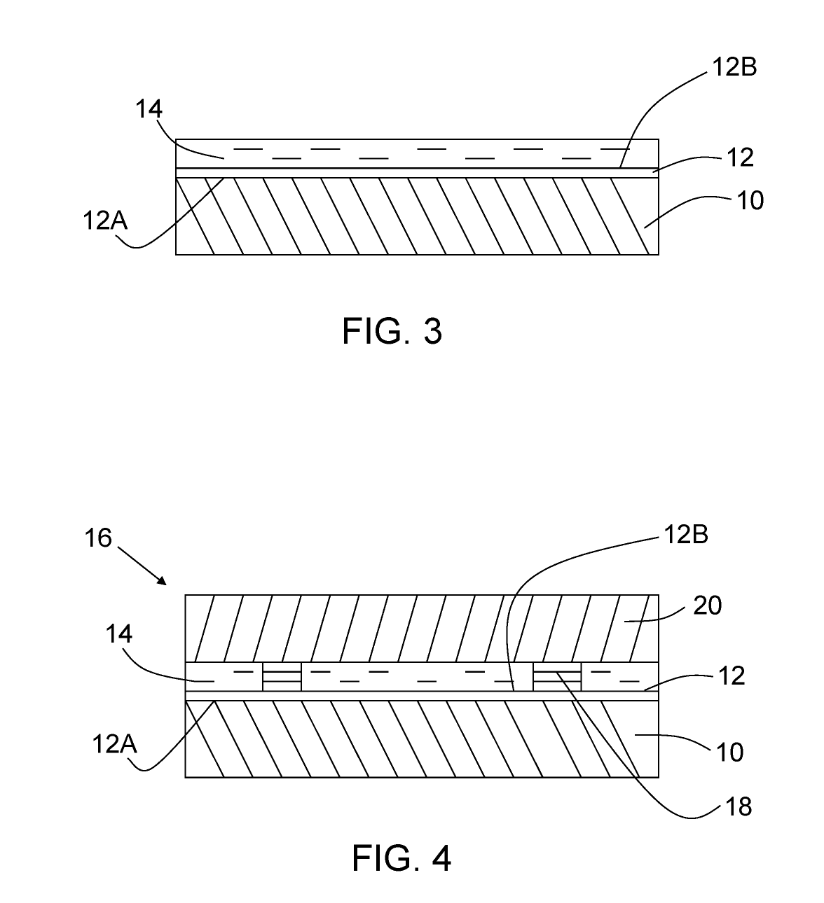

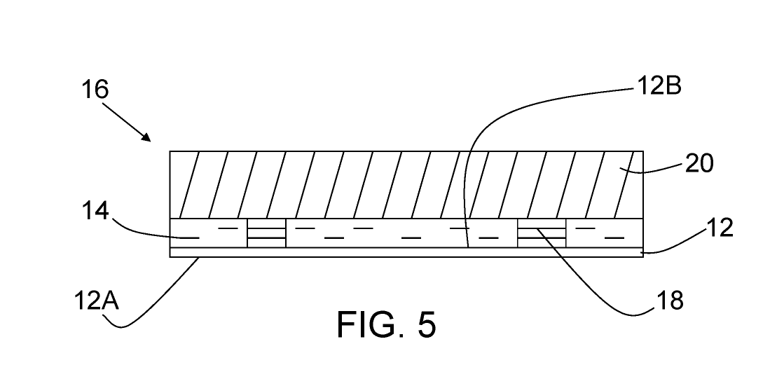

Specific example embodiments of an application of a multilayered polyimide film with a printed circuit board are illustrated in FIGS. 2-5. According to some embodiments, a multilayered polyimide film may comprise a peelable base layer 10 and a polyimide layer 12, wherein a peelable base layer 10 and a polyimide layer 12 may be adhered to each other. A polyimide layer 12 may have a first surface 12A and a second surface 12B opposite to each other. The first surface 12A of the polyimide layer 12 may be adhered in direct contact with the base layer 10, while the second surface 12B of the polyimide layer 12 may be exposed. According to some embodiments, as illustrated by FIG. 3, an adhesive substance may be applied on the second surface 12B of the polyimide layer 12, wherein an adhesive layer 14 may be formed. In some embodiments, as illustrated by FIG. 4, a multilayered polyimide film may be placed on a substrate 16, wherein the second surface 12B of the polyimide layer 12 may be adhered to the substrate 16. In some embodiments, the substrate 16 may be a printed circuit board comprising a metal layer 20 and a base substrate 18. In some embodiments, as illustrated by FIG. 5, the base layer 10 may then be peeled from the first surface 12A of the polyimide layer 12, wherein the polyimide layer 12 may be attached to the substrate 16.

Persons skilled in the art would understand that where ranges have been provided, the disclosed endpoints may be treated as exact and/or approximations as desired or demanded by a particular embodiment. Moreover, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint.

Examples of methods of fabricating multilayered polyimide films are described hereinafter.

### EXAMPLES

### Example 1

Preparation of a First Polyamic Acid Solution

About 44.31 g of 4,4′-oxydianiline (4,4′-ODA) and about 400 g of dimethylacetamide (DMAC) used as solvent are put into a three-necked flask, and agitated at a temperature of about 30° C. until complete dissolution. Then about 5.89 g of polydimethylsiloxane (PDMS) having an end functional group of a diamine is added and mixed homogeneously, and 49.05 g of pyromellitic dianhydride (PMDA) is added into the obtained solution. The quantity of the reacted monomers is 20 wt % of the total weight of the solution. The solution is continuously agitated and reaction occurs at a temperature of 25° C. for 25 hours to form a first polyamic acid (PAA) solution.

Preparation of a Second Polyamic Acid Solution

About 47.85 g of ODA and about 400 g of DMAC used as solvent are put into a three-necked flask, and agitated at a temperature of about 30° C. until complete dissolution. Then about 51.37 g of PMDA is added into the obtained solution. The quantity of the reacted monomers is 20 wt % of the total weight of the solution. The solution is continuously agitated and reaction occurs at a temperature of 25° C. for 25 hours to form a second PAA solution.

Preparation of the Ultra-Thin Polyimide Film

The first PAA solution is coated onto a glass plate and heated at 80° C. for 30 minutes to remove most of the solvent. Then, the glass plate with the coated first PAA solution thereon is placed in an oven and heated at 170° C. for 1 hour to form the base layer. The second PAA solution is coated onto the base layer and heated at 80° C. for 30 minutes. Then the glass plate with the first and second PAA solutions coated thereon is placed in an oven and heated at 170-370° C. for 4 hours to form a multilayered polyimide film including a peelable base layer and a polyimide layer stacked on each other. The multilayered polyimide film thereby formed can be peeled from the glass plate. The multilayered polyimide film has a total thickness of 30 μm, the thickness of the peelable base layer being 25 μm and the thickness of the polyimide film being 5 μm.

### Example 2

A multilayered polyimide film is prepared like in Example 1, except that the first PAA solution is prepared with 42.13 g of ODA, 9.53 g of PDMS having an end functional group of a diamine and 48.1 g of PMDA. The quantity of the reacted monomers is 20 wt % based on the total weight of the reaction solution.

### Example 3

A multilayered polyimide film is prepared like in Example 1, except that the first PAA solution is prepared with 23.27 g of ODA, 25.02 g of PDMS having an end functional group of a diamine and 31.71 g of PMDA. The quantity of the reacted monomers is 20 wt % based on the total weight of the reaction solution.

### Example 4

A multilayered polyimide film is prepared like in Example 1, except that the first PAA solution is prepared with 46.12 g of ODA, 4.61 g of PDMS having an end functional group of a dianhydride and 49.27 g of PMDA. The quantity of the reacted monomers is 20 wt % based on the total weight of the reaction solution.

### Example 5

A multilayered polyimide film is prepared like in Example 1, except that the first PAA solution is prepared with 43.75 g of ODA, 10.94 g of PDMS having an end functional group of a dianhydride and 45.31 g of PMDA. The quantity of the reacted monomers is 20 wt % based on the total weight of the reaction solution.

### Example 6

A multilayered polyimide film is prepared like in Example 1, except that the first PAA solution is prepared with 37.36 g of ODA, 28.02 g of PDMS having an end functional group of a dianhydride and 34.62 g of PMDA. The quantity of the reacted monomers is 20 wt % based on the total weight of the reaction solution.

### Example 7

A multilayered polyimide film is prepared like in Example 1, except that the first PAA solution is prepared with 46.63 g of ODA, 2.21 g of PDMS having an end functional group of a diamine and 50.57 g of PMDA. The quantity of the reacted monomers is 20 wt % based on the total weight of the reaction solution.

### Example 8

A multilayered polyimide film is prepared like in Example 1, except that the first PAA solution is prepared with 20.58 g of ODA, 29.5 g of PDMS having an end functional group of a diamine and 29.91 g of PMDA. The quantity of the reacted monomers is 20 wt % based on the total weight of the reaction solution.

### Example 9

A multilayered polyimide film is prepared like in Example 1, except that the first PAA solution is prepared with 46.97 g of ODA, 2.35 g of PDMS having an end functional group of a dianhydride and 50.68 g of PMDA. The quantity of the reacted monomers is 20 wt % based on the total weight of the reaction solution.

### Example 10

A multilayered polyimide film is prepared like in Example 1, except that the first PAA solution is prepared with 34.82 g of ODA, 34.82 g of PDMS having an end functional group of a dianhydride and 30.36 g of PMDA. The quantity of the reacted monomers is 20 wt % based on the total weight of the reaction solution.

The multilayered polyimide films prepared according to the aforementioned Examples are subject to the following testing.

Test of Peel Strength

Testing is conducted with a universal testing machine (Hounsfield H10ks) according to IPC-TM650 2.4.9 test method. First, a thermal bond 3L-FCCL (3-layer flexible copper clad laminate) substrate is prepared. A glue layer (8 cm×12 cm, prepared with the adhesive agent BH25EL3 purchased from Taiflex Scientific Co., Ltd) is applied on a surface of the multilayered polyimide film (9 cm×13 cm), and a copper foil (9 cm×13 cm) is pressed thereon at a temperature of 190° C. and pressure of 20 kgf/cm² for preheat time of 10 seconds and bonding time of 2 minutes. Then this assembly is baked at a temperature of 160° C. for 1 hour to obtain the FCCL substrate. The FCCL substrate is cut to form samples having 13 cm length and 0.33 cm width. The samples are further cut along the interface between the copper foil and the multilayered polyimide film for about 0.5 cm. At the incision, the outer surface of the multilayered polyimide film of the FCCL is adhered to a roller clamp, while the copper foil of the FCCL is clipped to the universal testing machine. For the test, the roller clamp maintains a rolling speed of about 50 mm/min, test temperature is 25±3° C., and it is then verified that peeling occurs at the interface between the copper foil and the multilayered polyimide film at a test angle of 90°.

Surface Energy

A contact angle detecting machine (DSA10-MK2, Kruss) may be used to measure the surface energy. The multilayered polyimide film (10 cm×10 cm) is placed on a plate. Drops of water and diiodomethane are applied on the multilayered polyimide film (in particular on an outer surface of the peelable base layer), and the contact angle of the drops is then measured. Owens-Wendt method may then run to calculate the surface energy based on the contact angles of both drops.

A peeling property of a multilayered polyimide film is defined as <0.4 kgf/cm, i.e., the base layer is peelable when the value of the surface energy is about 0.000001 kgf/cm to about 0.4 kgf/cm.

The results are shown in following Table 1.

TABLE 1

| | PI composition | | Si | Film | | |
|---|---|---|---|---|---|---|
| | Diamine | Dianhydride | content | formation | Surface Energy | Peeling |
| Example 1 | ODA_{0.97} + | PMDA | 1.5% | ◯ | 27.9 | Yes |
| | PDMS_{0.03} | | | | | |
| Example 2 | ODA_{0.95} + | PMDA | 3.5% | ◯ | 26.4 | Yes |
| | PDMS_{0.05} | | | | | |
| Example 3 | ODA_{0.8} + | PMDA | 11.6% | ◯ | 23.0 | Yes |
| | PDMS_{0.2} | | | | | |
| Example 4 | ODA | PMDA_{0.98} + | 1.7% | ◯ | 27.2 | Yes |
| | | PDMS_{0.02} | | | | |
| Example 5 | ODA | PMDA_{0.95} + | 4.1% | ◯ | 26.1 | Yes |
| | | PDMS_{0.05} | | | | |
| Example 6 | ODA | PMDA_{0.85} + | 10.4% | ◯ | 25.1 | Yes |
| | | PDMS_{0.15} | | | | |
| Example 7 | ODA_{0.99} + | PMDA | 0.8% | ◯ | 33.3 | No |
| | PDMS_{0.01} | | | | | |
| Example 8 | ODA_{0.75} + | PMDA | 13.7% | X | X | X |
| | PDMS_{0.25} | | | | | |
| Example 9 | ODA | PMDA_{0.99} + | 0.8% | ◯ | 31.6 | No |
| | | PDMS_{0.01} | | | | |
| Example 10 | ODA | PMDA_{0.8} + | 12.9% | X | X | X |
| | | PDMS_{0.2} | | | | |

In the cell “film formation” of Table 1, the symbol “0” means that film formation occurs, and the symbol “X” means there is no film formation. When the peelable base layer 10 has lower surface energy, it may have lower adherence and a larger liquid contact angle. As a result, a polyimide layer 12 may be more easily peeled off from a peelable base layer 10.

According to some embodiments, a multilayered polyimide film may comprise several advantages over conventional polyimide films. In some embodiments, the smallest thickness of a conventional single-layer polyimide film prepared with biaxial stretching may be about 10 μm. When single layer polyimide films are formed with a thickness less than 10 μm, a conventional processing method may require a lamination of a thinner polyimide film on a polyester tape (e.g., PET tape), and then assembly of the polyimide film and the polyester tape may be wound to form a roll. According to some embodiments, a multilayered polyimide film described herein may accommodate an ultra-thin polyimide layer comprising a thickness, wherein the thickness may be less than about 5 μm, and may allow biaxial stretching of the ultra-thin polyimide layer without incurring damages. According to some embodiments, after fabrication, a multilayered polyimide film may be wound to form a roll.

According to some embodiments, a multilayered polyimide film may facilitate an attachment of an ultra-thin polyimide layer on a substrate, wherein the base layer may be peeled off from the polyimide layer after it is adhered to the substrate. In some embodiments, a multilayered polyimide film may allow convenient processing of an ultra-thin polyimide layer, and may be fabricated at a reduced cost.

Realizations of multilayered polyimide films and its method of fabrication and assembly have been described in context of some embodiments. These embodiments are meant to be illustrative and not limiting. Many variations, modifications, additions, and improvements are possible. These and other variations, modifications, additions, and improvements may fall within the scope of the invention as defined in the claims that follow.

What is claimed is:

1. A multilayered polyimide film comprising:
a peelable base layer derived from a reaction comprising a diamine compound and a dianhydride compound, wherein the peelable base layer comprises a polyimide and a structure according to formula (I): 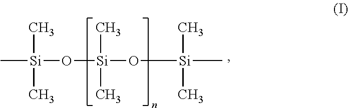
wherein n is a number of repeating units;
wherein a quantity of silicon atoms present in the peelable base layer comprises about 1% to about 12% of the total weight of the peelable base layer; and
a polyimide layer adhered in contact with a surface of the peelable base layer.

2. The polyimide film according to claim 1, wherein the polyimide layer has a thickness of about 0.1 μm to about 6 μm.

3. The polyimide film according to claim 1, wherein the peelable base layer further comprises a thickness of about 5 μm to about 10 μm.

4. The polyimide film according to claim 1, wherein the peelable base layer further comprises a surface energy of about 0.000001 kgf/cm to about 0.4 kgf/cm.

5. The polyimide film according to claim 1, wherein the polyimide layer comprises at least one pigment, wherein the at least one pigment comprises carbon black, titanium dioxide, and combinations thereof.

6. The polyimide film according to claim 1, wherein the diamine compound comprises a structure according to formula (I-A): 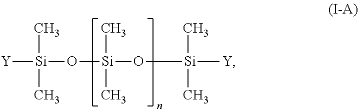
wherein Y is selected from the group consisting of 4,4′-oxydianiline (4,4′-ODA), phenylenediamine (p-PDA) and 2,2′-Bis(trifluoromethyl)benzidine (TFMB).

7. The polyimide film according to claim 1, wherein the dianhydride compound comprises a structure according to formula (I-A): 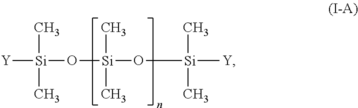
wherein Y is selected from the group consisting of pyromellitic dianhydride (PMDA), 3,3′,4,4′-biphenyl-tetracarboxylic dianhydride (BPDA), and 2,2-bis [4-(3,4dicarboxyphenoxy) phenyl] propane dianhydride (BPADA).

8. A multilayered polyimide film comprising:
a peelable base layer derived from a reaction of a diamine compound with a dianhydride compound, wherein the peelable base layer comprises a polyimide and a structure according to formula (II): 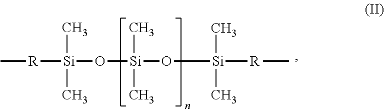
wherein n is a number of repeating units, R represents C1-C10 aliphatic group, and a quantity of silicon atoms present in the peelable base layer is between about 1% and about 12% of the total weight of the peelable base layer; and
a polyimide layer adhered in contact with a surface of the peelable base layer.

9. The polyimide film according to claim 8, wherein the polyimide layer comprises a thickness comprising about 0.1 μm to about 6 μm.

10. The polyimide film according to claim 8, wherein the peelable base layer comprises a thickness comprising about 5 μm to about 10 μm.

11. The polyimide film according to claim 8, wherein the peelable base layer comprises a surface energy of about 0.000001 kgf/cm to about 0.4 kgf/cm.

12. The polyimide film according to claim 8, wherein the polyimide layer comprises at least one pigment, wherein the at least one pigment comprises carbon black titanium dioxide, and a combination thereof.

13. The polyimide film according to claim 8, wherein the diamine compound comprises a structure according to formula (II-A): 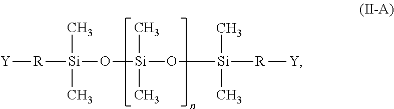
wherein Y is selected from the group consisting of 4,4′-oxydianiline (4,4′-ODA), phenylenediamine (p-PDA) and 2,2′-Bis(trifluoromethyl)benzidine (TFMB).

14. The polyimide film according to claim 8, wherein the dianhydride compound comprises a structure according to formula (II-A): 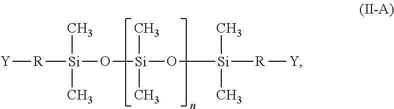
wherein Y is selected from the group consisting of pyromellitic dianhydride (PMDA), 3,3′,4,4′-biphenyl-tetracarboxylic dianhydride (BPDA), and 2,2-bis [4-(3,4dicarboxyphenoxy) phenyl] propane dianhydride (BPADA).
